(19) United States
(12) Patent Application Publication
(10) Pub. No.: US 2025/0094768 A1
(43) Pub. Date: Mar. 20, 2025

(54) MULTI-BRANCH MACHINE LEARNING MODELS FOR MULTI-DOMAIN AND MULTI-TASK PROCESSING

(71) Applicant: QUALCOMM Incorporated, San Diego, CA (US)

(72) Inventors: Andrii SKLIAR, Diemen (NL); Babak EHTESHAMI BEJNORDI, Amsterdam (NL); Amelie Marie Estelle ROYER, Amsterdam (NL); Tijmen Pieter Frederik BLANKEVOORT, Amsterdam (NL); Dushyant MEHTA, Amsterdam (NL)

(21) Appl. No.: 18/468,481

(22) Filed: Sep. 15, 2023

(51) Int. Cl. G06N 3/0442; G05D 1/02; G06N 3/045

(52) U.S. Cl. CPC G06N 3/0442; G06N 3/045

(57) ABSTRACT

Certain aspects of the present disclosure provide techniques and apparatus for training and inferencing using a multi-domain machine learning model. An example method generally includes extracting, using a first neural network block, a plurality of features associated with inputs in a multi-domain input data set. A confusion matrix is generated based on the extracted plurality of features. A plurality of clusters is identified from the confusion matrix. Each cluster in the plurality of clusters generally corresponds to one or more data domains in the multi-domain input data set. A first gating neural network is trained based on the multi-domain input data set and the identified plurality of clusters. A plurality of second neural network blocks is trained based on a division of the multi-domain input data set into data associated with each cluster of the plurality of clusters.

### INTRODUCTION

Aspects of the present disclosure relate to machine learning models.

Machine learning models can be used to perform various tasks, such as tasks based on computer vision, natural language processing, audio processing, and the like. Single-purpose models may be trained to perform a specific task. For example, in an autonomous driving scenario, different models may be trained to perform semantic segmentation (e.g., to divide visual content into different regions corresponding to different types of objects), object detection, motion prediction, and the like. In another example, generative artificial intelligence models may be trained to generate responses to queries from different data domains. In such a case, one model may be trained to generate responses based on a general knowledge database, and other models may be trained to generate responses based on domain-specific knowledge databases.

Training and maintaining multiple machine learning models to perform a variety of tasks may be computationally expensive. Further, it may be computationally infeasible to deploy multiple models for use in various applications, such as in autonomous driving, virtual reality, or other applications in which machine learning models generate various outputs that are used to perform a downstream task (e.g., in an autonomous driving scenario, to generate depth maps, segmentation maps, and the like, the combination of which may be used to identify obstacles in the path of an autonomous vehicle and generate control outputs that modify the direction and/or velocity of the autonomous vehicle in an attempt to avoid collisions with these identified obstacles). Thus, to reduce the computational expense of maintaining and executing multiple machine learning models, a single machine learning model may be trained using various techniques (e.g., transfer learning). However, training a single model to perform multiple tasks may result in compromised inference accuracy for some tasks due to conflicts between these tasks such that improving inference performance for one task results in decreased inference performance for a conflicting task (also known as negative transfer or destructive interference).

### BRIEF SUMMARY

Certain aspects of the present disclosure provide a processor-implemented method for inferencing using a multi-domain machine learning model. An example method generally includes extracting, using a first neural network block, a plurality of first features from a received input. Using a gating neural network and the plurality of first features, a second neural network block from a plurality of second neural network blocks is identified to use in processing the received input, each neural network in the plurality of second neural network blocks being trained to process data from a cluster of related domains in a universe of domains. The received input is processed using the identified second neural network block from the plurality of second neural network blocks.

Certain aspects of the present disclosure provide a processor-implemented method for training a multi-domain machine learning model. An example method generally includes extracting, using a first neural network block, a plurality of features associated with inputs in a multi-domain input data set. A confusion matrix is generated based on the extracted plurality of features. A plurality of clusters is identified from the confusion matrix. Each cluster in the plurality of clusters generally corresponds to one or more data domains in the multi-domain input data set. A first gating neural network is trained based on the multi-domain input data set and the identified plurality of clusters. A plurality of second neural network blocks is trained based on a division of the multi-domain input data set into data associated with each cluster of the plurality of clusters.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example of a gating neural network for routing an input to one of a plurality of neural networks in a multi-branch neural network for processing, according to aspects of the present disclosure.

FIG. 2 illustrates an example pipeline for training a feature extractor neural network and a gating neural network to extract features usable for routing and inferencing in a multi-branch neural network, according to aspects of the present disclosure.

FIG. 3 illustrates an example pipeline for training a feature extractor neural network and a gating neural network to extract features usable for routing and inferencing in a multi-branch neural network, according to aspects of the present disclosure.

FIG. 4 illustrates an example multi-branch neural network, according to aspects of the present disclosure.

FIG. 5 illustrates example operations for training a multi-branch neural network including a gating neural network and a plurality of task-specific neural network blocks, according to aspects of the present disclosure.

FIG. 6 illustrates example operations for inferencing through a multi-branch neural network including a gating neural network and a plurality of task-specific neural network blocks, according to aspects of the present disclosure.

FIG. 7 depicts an example processing system configured to perform various aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for training and inferencing using multi-branch machine learning models.

Generally, machine learning models may be trained and deployed to generate inferences relevant to a specific input data set and/or a specific type of output to be generated based on an input. For example, in image analysis tasks, some machine learning models may be trained to recognize different objects in an input image (e.g., to perform object detection or semantic segmentation of an image), while other machine learning models may be trained to recognize text included in an image. Further, amongst image classification tasks, different models may be specialized for different types of image data analysis, such as facial detection, animal detection, plant detection, place detection, medial abnormality analysis, and so on. In another example, in systems that use generative artificial intelligence models to generate responses to input prompts (or queries), different models may be trained to generate answers for different domains. For example, one model may be trained to generate responses to general knowledge prompts, and other models may be trained as domain-specific models to generate responses to prompts in specific domains (e.g., law, medicine, etc.).

Training and maintaining multiple machine learning models to perform a variety of tasks, as discussed, may be computationally expensive. Thus, to reduce the computational expense of maintaining multiple models, transfer learning techniques can be used to generate a model that can perform multiple related tasks. In transfer learning, machine learning models pre-trained on large-scale datasets can leverage the knowledge obtained from one dataset to perform a different but related task (e.g., transferring classification-related knowledge for classifying one type of object to classifying a different type of object in image data). While transfer learning can be a powerful tool for building a model that can generate inferences based on data in various domains, transfer learning may result in degraded inference performance for some tasks due to conflicts between training the model to perform different tasks (e.g., destructive interference between different tasks).

Aspects of the present disclosure provide techniques for training and inferencing using a multi-domain machine learning model. As discussed in further detail herein, a multi-domain machine leaning model generally allows for data from any of a plurality of data domains to be input into a machine learning model. The machine learning model generally includes one or more gating neural networks that route the input to one of a plurality of downstream neural networks, each of which may be trained to perform a specific task with respect to a specific data domain. By training a machine learning model to route inputs to one of a plurality of downstream neural networks, aspects of the present disclosure may allow for a machine learning model to perform various tasks with respect to data from various domains while maintaining a desired degree of inference performance for each of a plurality of tasks. That is, unlike techniques such as transfer learning, in which destructive interference can adversely affect inference performance for data in some domains or for different conflicting tasks, aspects of the present disclosure provide a machine learning model that can accurately perform a variety of tasks on data from a variety of data domains. Further, because the machine learning model may be a unified model capable of performing various tasks on various types of data, aspects of the present disclosure may reduce computational resource utilization (e.g., processor time, memory utilization, network bandwidth, storage space, etc.) for training, deploying, and maintaining machine learning models. Instead of maintaining multiple models, each of which may have its own computational overhead, aspects of the present disclosure may provide for a single machine learning model having a computational resource utilization less than that of a set of single-purpose machine learning models used to perform specific tasks with respect to specific domains of input data.

### Example Multi-Branch Machine Learning Models for Multi-Input and Multi-Task Processing

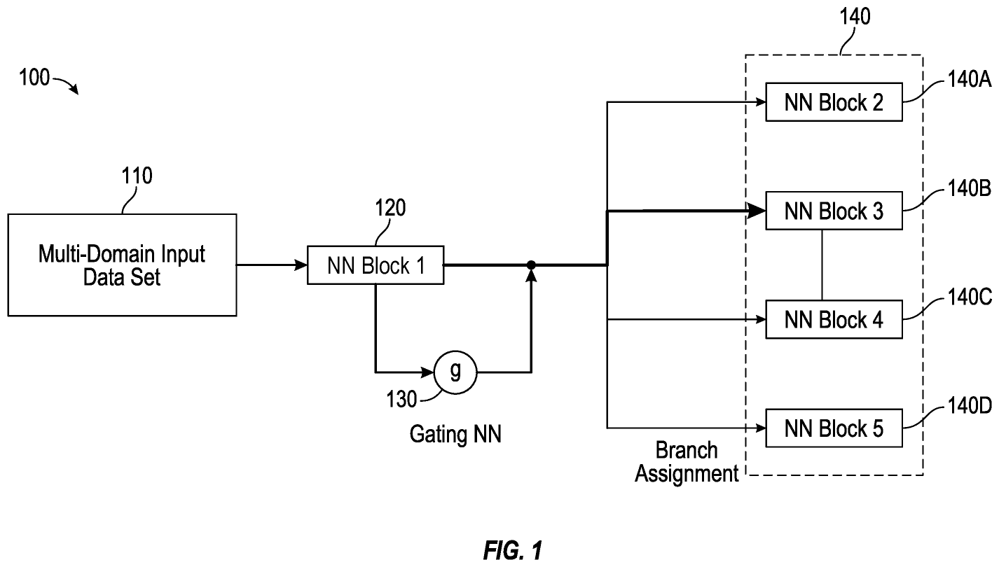

FIG. 1 illustrates an example of a gating neural network for routing an input to one of a plurality of neural networks in a segment 100 of a multi-branch neural network for processing, according to aspects of the present disclosure.

As illustrated, the segment 100 of the multi-branch neural network includes a first neural network block 120, a gating neural network 130, and a plurality of second neural network blocks 140 (also referred to as “task-specific neural network blocks”). To train the segment 100 of the multi-branch neural network, a multi-domain input data set 110 may be input into the first neural network block 120. The first neural network block 120 may, in some aspects, be a feature extractor that extracts one or more features from each input in the multi-domain input data set 110 for use in training the gating neural network 130 and for use as an input into the gating neural network 130 to control routing of an input to one of the plurality of second neural network blocks 140.

The multi-domain input data set 110 includes data from a plurality of different data domains. For example, the plurality of different data domains may correspond to different types of image data which can be processed by different types of neural networks, different types of natural language prompts which can be processed by different natural language processing neural networks, and so on. Because the multi-domain input data set 110 includes data from a plurality of different data domains, the first neural network block 120 may extract features from the multi-domain input data set 110 into a plurality of different feature spaces, where each individual feature space corresponds to a different data domain. For example, where the segment 100 corresponds to an initial branch in the multi-branch neural network, the features extracted by the first neural network block 120 may include features that allow for the differentiation of an input into one of a plurality of broad data domains included in the multi-domain input data set (e.g., to classify an input as an image to be routed to one of a plurality of image processing neural networks or a natural language prompt to one of a plurality of natural language processing generative artificial intelligence models). In another example, where the segment 100 corresponds to a downstream branch of the multi-domain neural network from the initial branch, the features extracted by the first neural network block 120 may include features that allow for the differentiation of an input into one of a plurality of finer classes corresponding to a specific neural network used to process the input (e.g., for image data, differentiation between scene data for which object detection tasks are to be performed and character set data for which character recognition tasks are to be performed).

Generally, the number of different classes, or domains, of data in the multi-domain input data set 110 may be unknown when the gating neural network 130 is trained. Thus, to train the gating neural network 130, a confusion matrix may be generated based on the features extracted by the first neural network block 120 for each input in the multi-domain input data set 110. The confusion matrix generally is a matrix illustrating a correlation between different inputs in the multi-domain input data set 110. Each entry in the confusion matrix generally may be a score that describes a similarity between a pair of inputs in the multi-domain input data set 110.

To partition the multi-domain input data set 110 into a plurality of domains for which the second neural network blocks 140 are to be trained, the confusion matrix may be processed using a graph clustering algorithm, such as (but not limited to) the Pairwise Agglomeration Induced by Sampling (PARIS) algorithm, to generate a graph illustrating a division of the multi-domain input data set 110 into a plurality of domains. The domains may be identified based on a cluster quality metric, such as a threshold similarity between different inputs in the multi-domain input data set 110. The identified domains may be used as a supervision signal to train the gating neural network 130 to route an input to an appropriate second neural network block 140A-140D of the second neural network blocks 140 and to partition the multi-domain input data set 110 into groups of data which can be used to train the second neural network blocks 140 (and, in some aspects, one or more further downstream neural network blocks).

The supervision signal may, for example, be a label applied to each input in the multi-domain input data set 110. The resulting labeling may allow for the gating neural network 130 to be trained using supervised learning techniques. Thus, in some aspects, the gating neural network 130 may be trained as a classifier neural network that classifies an input into one of a plurality of classes. The plurality of classes into which the input may be classified may correspond to classes identified based on the graph clustering algorithm and the confusion matrix. Further, the classification labels generated based on the clustering algorithm and the confusion matrix may be used to train the second neural network blocks 140, which, as discussed, may be neural networks configured to process specific types of data and/or to generate further features from an input that can be used by another gating neural network to route an input to a further downstream neural network and/or task head for processing.

As discussed, the second neural network blocks 140 generally include a plurality of neural network blocks 140A-140D (and other neural networks, not illustrated in FIG. 1). Generally, each second neural network block 140A-140D may be a neural network trained to process a specific category of data identified based on the confusion matrix and the graph clustering algorithm discussed above. To train a second neural network block 140, data relevant to the second neural network block 140 (e.g., data labeled with a specific classification, such as image data or textual data) may be extracted from the multi-domain input data set 110. The extracted data may then be used to train the second neural network block 140 to perform a task specific to the domain of data associated with the second neural network block 140.

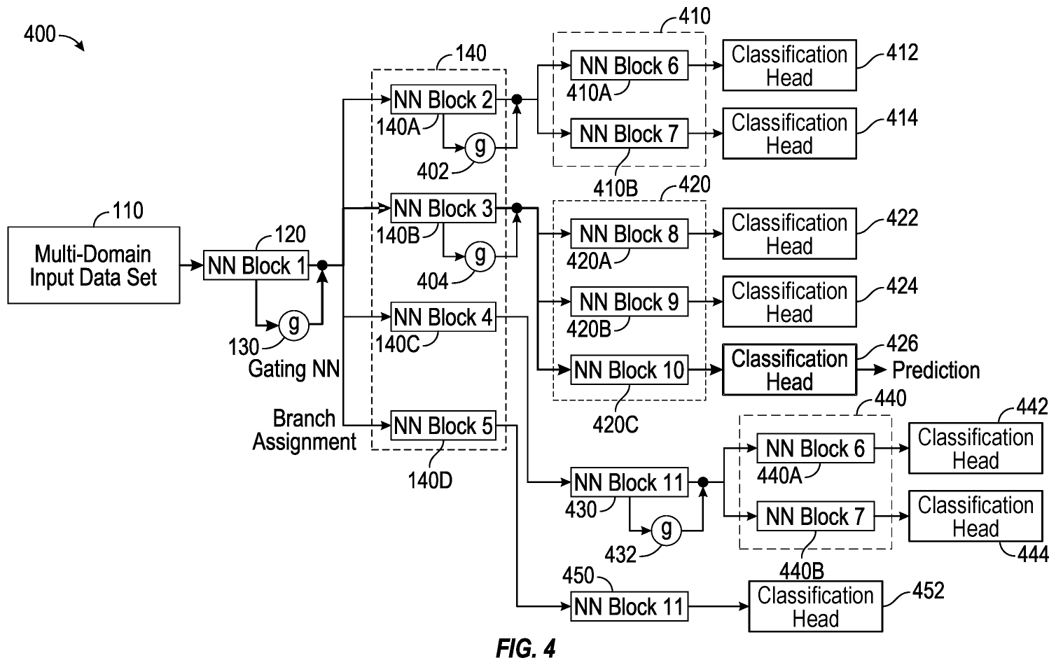

In some aspects (e.g., as illustrated in FIG. 4 and discussed in further detail below), where the second neural network block 140 is an intermediate network between the first neural network block 120 and a downstream neural network that is coupled with a task head to perform a specific task with respect to the input, the second neural network block 140 may be trained to extract further features that can be used to route the input to the appropriate downstream neural network block through another gating neural network. In some aspects, where the second neural network block 140 is a terminal neural network in the multi-branch neural network (e.g., a neural network coupled to a task head that ultimately performs a task with respect to the input), the second neural network block 140 may be trained to generate features which are fed into the task head in order to generate an appropriate output for the input. For example, the task head may include a semantic segmentation task head which can segment an input image into segments corresponding to different types of objects in the input image, an object detection task head which can identify specific instances of objects in the input image, a motion prediction task head which can identify objects and predict how these objects will move in the future, a general knowledge generative model task head which can generate a response to a wide variety of input prompts, domain-specific generative model task heads which can generate domain-specific responses, or the like.

In some aspects, the gating neural network 130 and the second neural network blocks 140 may be trained independently. After the gating neural network 130 and the second neural network blocks 140 are trained, the gating neural network 130 and the second neural network blocks 140 may be jointly refined to improve the accuracy with which the gating neural network 130 classifies an input and the accuracy with which the second neural network blocks 140 perform a downstream task with respect to the input.

In some aspects, the gating neural network 130 may be trained based on a minimization, or at least optimization, of two loss functions. In particular aspects, the first loss function may be a task-specific loss function, such as a cross-entropy loss function for a classification task, which may be optimized via gradient descent or other techniques. In particular aspects, the second loss function may be a loss function that minimizes, or at least reduces, the error between predictions made by the gating neural network 130 and classifications generated based on the clustering techniques discussed above (e.g., clusters generated based on a confusion matrix generated for the input data set 110). In other aspects, other first and/or second loss functions may be implemented.

In some aspects, features learned by the gating neural network 130 and the second neural network blocks 140 (and, though not shown, downstream neural networks from the second neural network blocks 140) may be different from features that would be learned by a neural network directly from a training data set. For example, the features learned for classification of an input through the gating neural network 130 (also referred to as an early exit output of the multi-branch neural network) may be different from the features that may be useful in performing a specific task at one of the second neural network blocks 140 (or neural networks downstream from the second neural network blocks 140). Thus, the features learned for classification of an input through the gating neural network 130 may not be usable by task-specific neural network blocks in ultimately performing a specific task (e.g., semantic segmentation, object detection, motion prediction, text recognition, response generation, etc.). To allow the first neural network block 120 and the second neural network blocks 140 (as well as other downstream neural networks, not illustrated in FIG. 1) to learn relevant features, various techniques can be used to jointly train the first neural network block 120, the gating neural network 130, and the second neural network blocks 140 to extract features which can be used both for classification (and thus for gating through the gating neural network 130) and downstream tasks.

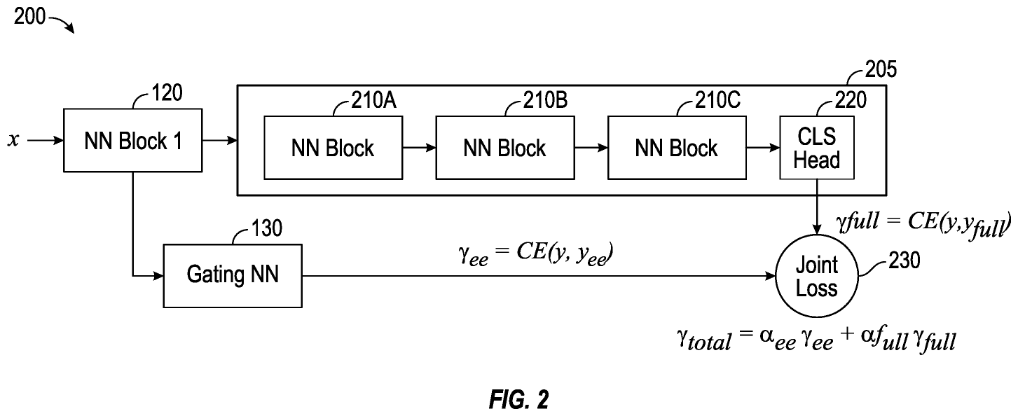

FIG. 2 illustrates an example pipeline 200 for training a feature extractor neural network (e.g., the first neural network block 120 illustrated in FIG. 1) and a gating neural network (e.g., the gating neural network 130 illustrated in FIG. 1) to extract features usable for routing and inferencing in a multi-branch neural network, according to aspects of the present disclosure.

In pipeline 200, the first neural network block 120 receives an input x (e.g., a sample from the multi-domain input data set 110) and extracts a plurality of features from the input x. The extracted plurality of features may be output from the first neural network block 120 to both the gating neural network 130 and a temporary task head 205. The extracted plurality of features may be used during training of the first neural network block 120 and the gating neural network 130 but may be discarded prior to deployment of the multi-branch neural network (e.g., such that the temporary task head is not used during inferencing operations). The gating neural network 130 may, in some aspects, be a classification neural network that generates the confusion matrix discussed above based on which a multi-domain input data set (e.g., the multi-domain input data set 110 illustrated in FIG. 1) can be organized and labeled for use in training the gating neural network 130 and the second neural network blocks 140.

The temporary task head 205 generally includes one or more temporary neural network blocks 210A-210C (collectively referred to as temporary neural network blocks 210) and a classification head 220. The one or more temporary neural network blocks 210 generally are trained to extract features from an input of features extracted from another neural network. For example, as illustrated, the features extracted from the input x by the first neural network block 120 may be input into the temporary neural network block 210A, which extracts a first intermediate set of features from the features extracted from the input x. This first intermediate set of features may be provided as an input into the temporary neural network block 210B, which generates a second intermediate set of features. This process may continue for each temporary neural network block 210 in the temporary task head 205. The output of the final temporary neural network block 210 (e.g., the temporary neural network block 210C illustrated in FIG. 2) may be provided as an input into the classification head 220. The classification head generates a classification for the input x which can be used to calculate a joint loss 230 based on which the first neural network block 120 and the gating neural network 130 can be trained. Although the temporary task head 205 in the pipeline 200 includes three temporary neural network blocks 210, in other aspects, any number of temporary neural network blocks may be implemented in any of the pipelines described herein.

As discussed, the classification generated by the gating neural network 130 may be considered an early exit output of a multi-branch neural network. Meanwhile, the classification generated by the classification head 220 may be treated as the full output of the multi-branch neural network. Thus, to train the first neural network block 120 to extract features usable in inferencing at the classification head 220 and in routing an input using the gating neural network 130, the joint loss 230 may be calculated based on an early exit loss and a full loss. The early exit loss, γₑₑ, may be calculated as the cross-entropy loss between a ground-truth classification y of the input x and the classification yₑₑ of the input x by the gating neural network 130, such that γₑₑ=CE(y, yₑₑ). Meanwhile, the full loss, γ_{full}, may be calculated as the cross-entropy loss between the ground truth classification y of the input x and the classification y_{full} of the input x by the classification head 220.

A total loss may thus be calculated according to the equation:

$${γ}_{total} = {α}_{ee} {γ}_{ee} + {α}_{full} {γ}_{full}$$

where αₑₑ represents a weight assigned to the early exit loss and α_{full} represents a weight assigned to the full loss. The weights αₑₑ and α_{full} may be selected to weight the training of the first neural network block 120 to generate features that are more relevant to classification at the gating neural network 130 or to inferencing using a downstream neural network (e.g., the second neural network blocks 140 or neural networks downstream of the second neural network blocks 140).

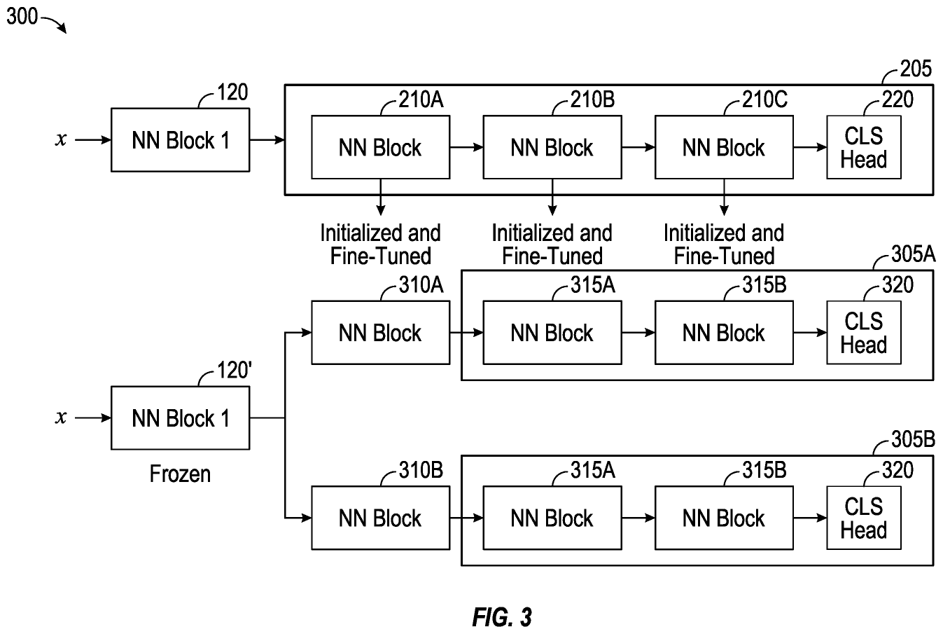

FIG. 3 illustrates an example pipeline 300 for training a feature extractor neural network (e.g., the first neural network block 120 illustrated in FIG. 1) and a gating neural network (e.g., the gating neural network 130 illustrated in FIG. 1) to extract features usable for routing and inferencing in a multi-branch neural network, according to aspects of the present disclosure.

As illustrated, the first neural network block 120 receives an input x and generates a set of output features that may be input into the temporary task head 205 (as illustrated in FIG. 2 and discussed above). The temporary task head 205, which, as discussed, includes a plurality of temporary neural network blocks 210 and a classification head 220, may be initialized as discussed above, based on minimizing, or at least reducing, a joint loss defined as a weighted combination of an early exit loss and a full loss.

To further train the multi-branch neural network to extract features relevant to both initial classification and downstream tasks, the first neural network block 120 may be frozen into a frozen first neural network block 120′. The output of the frozen first neural network block 120′ may be provided as an input into neural network blocks 310 (310A, 310B). The neural network blocks 310 may be initialized based on the learned weights for the first temporary neural network block 210A in the temporary task head 205. The temporary task head 205 may thus be converted to a smaller temporary task head 305 (305A, 305B), including a plurality of temporary neural network blocks 315 (315A, 315B) and a classification head 320. The plurality of temporary neural network blocks 315 may be initialized based on the corresponding temporary neural network block 210 in the temporary task head 205.

After the neural network blocks 310 and the temporary neural network blocks 315 in the temporary task head 305 are initialized, the neural network blocks 310 may be trained to extract features which are usable in both initial classification (e.g., for the gating neural network 130 to use in routing an input to the appropriate downstream neural network(s) for processing) and in task-specific operations on different types of inputs. The training of the neural network blocks 310 and the temporary neural network blocks 315 in the temporary task head 305 may proceed as discussed above with respect to FIG. 2, such that the neural network blocks 310 are trained based on minimization, or at least reduction, of a joint loss calculated as a weighted sum of an early exit loss and a full loss. After the neural network blocks 310 have been trained, the temporary task head 305 may be discarded, and the frozen first neural network block 120′ and the neural network blocks 310 may be deployed to generate features which can be used by a gating neural network to route inputs to the appropriate downstream neural network for processing.

While the foregoing illustrates two neural network blocks 310A and 310B for simplicity of illustration, it should be recognized by one of skill in the art that a neural network may include any number of neural network blocks.

FIG. 4 illustrates an example multi-branch neural network 400, according to aspects of the present disclosure. The multi-branch neural network 400, as illustrated, includes at least the segment 100 of the multi-branch neural network illustrated in FIG. 1, as well as one or more neural network blocks downstream of the segment 100 of the multi-branch neural network.

As illustrated, the multi-branch neural network 400 may have a number of navigable paths from the first neural network block 120, which receives as input data from one of a plurality of data domains (e.g., an input from the multi-domain input data set 110 or an input in a data domain included in the multi-domain input data set 110). The input, from the multi-domain input data set 110, may be input into the first neural network block 120 to extract a plurality of features which can be used by the gating neural network 130 to identify which second neural network block 140A-140D of the plurality of second neural network blocks 140 to which the input should be routed.

As illustrated, the second neural network blocks 140 may include a plurality of neural networks which can generate features that can be used by one or more downstream neural networks for routing and/or inferencing. For an input routed by the gating neural network 130 to the second neural network block 140A, a gating neural network 402 can be used to route the input to the appropriate downstream neural network 410 (e.g., to one of neural network blocks 410A or 410B). Each of the neural network blocks 410A and 410B may be coupled to a respective classification head 412 and 414, respectively. These classification heads 412 and 414 can use features extracted from an input by their respective neural network blocks 410A and 414B in order to perform a downstream task (e.g., as illustrated in FIG. 4, a classification task, though it should be recognized by one of skill in the art that tasks other than classification may be performed by a downstream neural network).

Similarly, for an input routed by the gating neural network 130 to the second neural network block 140B, a gating neural network 404 can be used to route the input to the appropriate downstream neural network 420. Each of the neural network blocks 420A, 420B, and 420C may be coupled to respective classification heads 422, 424, and 426, each of which may be trained to perform a different task or to process a specific type of data input into the multi-branch neural network 400.

For an input routed by the gating neural network 130 to the second neural network block 140C, features extracted by the second neural network block 140C may be output to a downstream neural network 430. The downstream neural network 430 may be trained to extract a further set of features which may be used by a gating neural network 432 to identify a downstream neural network 440 to which the input is to be routed. The features extracted by at least the downstream neural network 430 may be provided to the downstream neural network 440A or 440B for processing, based on the selection of the downstream neural network 440A or 440B by the gating neural network 432. The output of the neural networks 440A or 440B may be provided to the associated classification heads 442 or 444, respectively, for further processing.

Finally, for an input routed by the gating neural network 130 to the second neural network block 140D, a downstream neural network 450 may be used to generate an output which can be used by the associated classification head 452 to perform a downstream task.

Thus, as illustrated, the multi-branch neural network 400 can be trained to perform tasks with respect to inputs in a variety of domains by using one or more gating neural networks to route inputs to the appropriate downstream neural network for processing. Because the multi-branch neural network 400 allows for inputs from various domains to be processed and for various types of outputs to be generated from these inputs, aspects of the present disclosure may allow for the training of a single neural network to perform various tasks with respect to various data domains, as opposed to techniques in which discrete neural networks are trained and deployed to perform a specific task with respect to a specific data domain. Because the multi-branch neural network may be a single neural network that can perform various tasks, aspects of the present disclosure may thus reduce the amount of computational resources used to train, deploy, and maintain neural networks to perform specific tasks with respect to a specific type of input.

### Example Operations for Training and Inferencing Using a Multi-Branch Machine Learning Models for Multi-Input and Multi-Task Processing

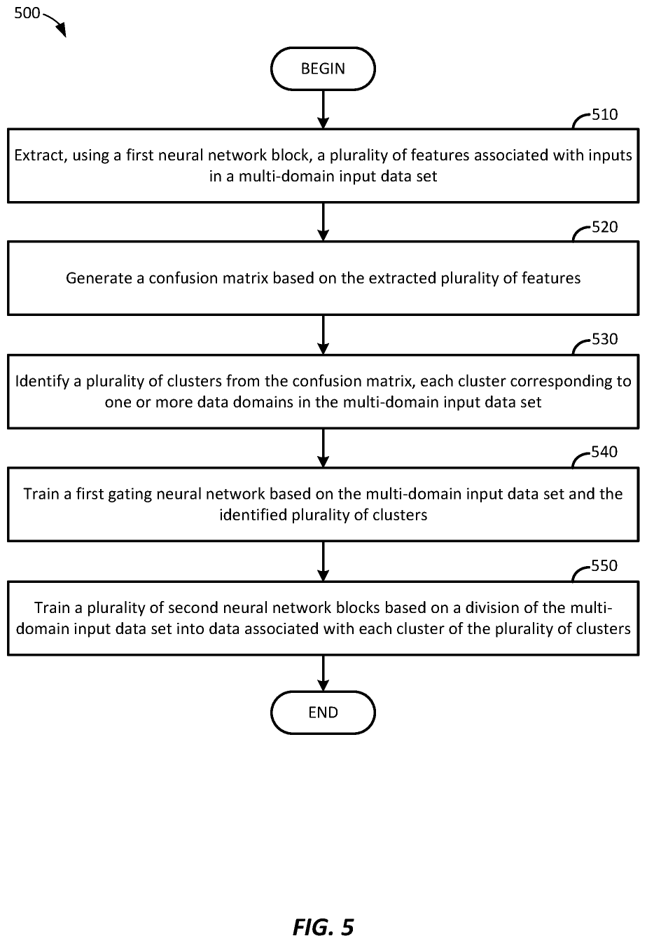

FIG. 5 illustrates example operations 500 that may be performed by a computing device to train a multi-branch neural network for multi-input and multi-task processing, according to aspects of the present disclosure. The operations 500 may be performed by a computing system capable of training one or more machine learning models, such as a server computer, a cloud computing instance, or the like.

As illustrated, the operations 500 begin at block 510, with extracting, using a first neural network block, a plurality of features associated with inputs in a multi-domain input data set.

In some aspects, the first neural network block may be a neural network configured to output features associated with a received input to a neural network selected from the plurality of second neural network blocks for processing.

At block 520, the operations 500 proceed with generating a confusion matrix based on the extracted plurality of features.

At block 530, the operations 500 proceed with identifying a plurality of clusters from the confusion matrix. Generally, each cluster in the plurality of clusters may correspond to one or more data domains in the multi-domain input data set.

In some aspects, identifying the plurality of clusters from the confusion matrix may include identifying data domains in the multi-domain input data set having a clustering quality score above a threshold value. The clustering quality score may be a distance score associated with a sampling ratio of a first data domain and a second data domain from the multi-domain input data set. In some aspects, the distance score may be based on a joint distribution of data in the first data domain and the second data domain and a product distribution of data in the first data domain and the second data domain.

At block 540, the operations 500 proceed with training a first gating neural network based on the multi-domain input data set and the identified plurality of clusters.

At block 550, the operations 500 proceed with training a plurality of second neural network blocks based on a division of the multi-domain input data set into data associated with each cluster of the plurality of clusters.

In some aspects, training the plurality of second neural network blocks may include training the first neural network block to extract a set of features from the multi-domain input data set including first features associated with the first gating neural network and second features associated with a downstream task performed by a second neural network block from the plurality of second neural network blocks. The second neural network block may be trained based on the second features.

In some aspects, training the first neural network block and the second neural network block comprises training the first neural network block and the second neural network block based on a joint loss function including a loss calculated for the first gating neural network and a loss calculated for the second neural network block.

In some aspects, training the first neural network block to extract the first features and the second features comprises extracting a plurality of features through one or more temporary feature extractors. The first neural network block may be a frozen feature extractor configured to generate the first set of features and a plurality of trained feature extractors configured to generate the second set of features. The plurality of trained feature extractors may be initialized based on parameters associated with a first feature extractor from the one or more temporary feature extractors.

In some aspects, the operations 500 may further include training a second gating neural network to route requests to one of a plurality of third neural network blocks. The second gating neural network may be associated with a neural network from the plurality of second neural network block. The plurality of third neural network blocks may be trained to perform one or more specified tasks based on data in the multi-domain input data set associated with a cluster associated with the neural network from the plurality of second neural network blocks. In some aspects, the plurality of third neural network blocks may include a plurality of classification neural networks trained to classify an input into one of a plurality of categories.

In some aspects, clusters in the plurality of clusters are divided based on types of data included in the multi-domain input data set.

In some aspects, the plurality of second neural network blocks comprises neural networks trained to classify images from one of a plurality of image data domains. In some aspects, the plurality of second neural network blocks comprises generative artificial intelligence models trained to generate responses to prompts in one of a plurality of task-specific domains. In some aspects, the plurality of second neural network blocks comprises generative artificial intelligence models trained to generate responses to prompts in one of a plurality of data-specific domains. For example, these data-specific domains may include, without limitation, a medical data domain, a legal data domain, a scientific data domain, or other data-specific domains.

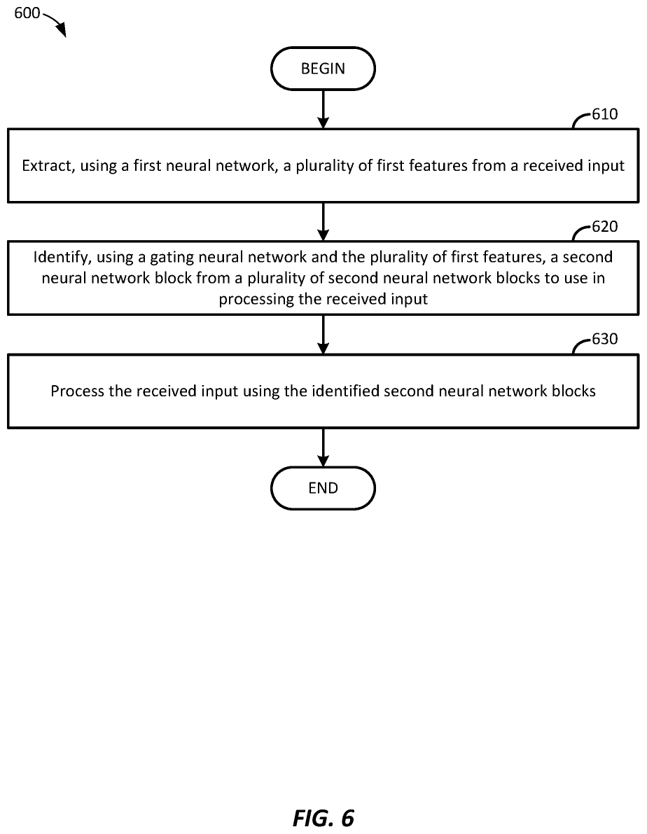

FIG. 6 illustrates example operations 600 that may be performed by a computing system for inferencing through a multi-branch neural network including a gating neural network and a plurality of task-specific neural network blocks, according to aspects of the present disclosure. The operations 600 may be performed by a computing system on which one or more neural networks can be deployed for inferencing on various types of data, such as a smartphone, a tablet computer, a desktop computer, an edge device, or the like.

As illustrated, the operations 600 begin at block 610 with extracting, using a first neural network block, a plurality of first features from a received input.

In some aspects, extracting the plurality of first features from the received input may include extracting features usable by the gating neural network to identify the second neural network block from the plurality of second neural network blocks to process the received input. Features usable by the second neural network block from the plurality of second neural network blocks may be extracted. These features may, in some aspects, be usable by the second neural network block to generate an inference from the received input. In some aspects, the second neural network block may include a feature extractor block and a task head configured to generate the inference based on features extracted by the feature extractor block.

At block 620, the operations 600 proceed with identifying, using a gating neural network and the plurality of first features, a second neural network block from a plurality of second neural network blocks to use in processing the received input. Generally, each neural network in the plurality of second neural network blocks may be trained to process data from a cluster of related domains in a universe of domains. In some aspects, the gating neural network comprises a clustering neural network trained to classify an input into one of a plurality of data domains based on similarities to data in different data domains in a multi-domain data set.

At block 630, the operations 600 proceed with processing the received input using the identified second neural network block from the plurality of second neural network blocks.

In some aspects, processing the received input using the identified second neural network block may include extracting a plurality of second features from the received input using the identified second neural network block. Using a gating neural network associated with the identified neural network, a third neural network from a plurality of third neural network blocks may be identified for use in processing the received input. Generally, each neural network in the plurality of third neural network blocks may be trained to perform a specified task. The received input is processed using the identified third neural network from the plurality of third neural network blocks.

In some aspects, the first neural network block and the plurality of second neural network blocks comprise jointly trained neural network blocks.

In some aspects, the plurality of second neural network blocks comprise neural networks trained to classify images from one of a plurality of image data domains. The output of these neural networks may be provided, for example, to an autonomous vehicle control system to trigger the generation of control signals to control the autonomous vehicle based on the output of these neural networks (e.g., to control the direction and/or speed of the autonomous vehicle in order to minimize, or at least reduce, a risk of colliding with an object identified in an image). In some aspects, the plurality of second neural network blocks comprise generative artificial intelligence models trained to generate responses to prompts in one of a plurality of task-specific domains. In some aspects, the plurality of second neural network blocks comprise generative artificial intelligence models trained to generate responses to prompts in one of a plurality of data-specific domains.

### Example Processing System for Training and Inferencing Using a Multi-Branch Machine Learning Models for Multi-Input and Multi-Task Processing

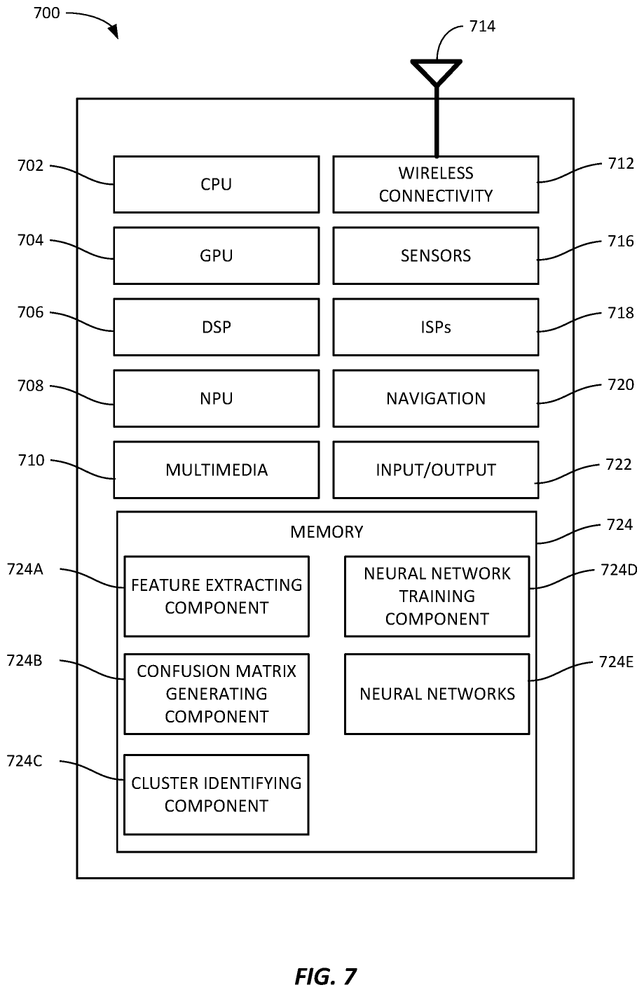

FIG. 7 depicts an example processing system 700 (or computing system) for training a multi-branch machine learning model for multi-input and multi-task processing, such as described herein for example with respect to FIG. 5.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., of memory 724).

The processing system 700 may also include additional processing components tailored to specific functions, such as a graphics processing unit (GPU) 704, a digital signal processor (DSP) 706, a neural processing unit (NPU) 708, and a connectivity component 712.

An NPU, such as the NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 708 is a part of one or more of the CPU 702, the GPU 704, and/or the DSP 706. These may be located on a user equipment (UE) in a wireless communication system or another computing device.

In some examples, a connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 712 may be further coupled to one or more antennas (not shown).

In some examples, one or more of the processors of the processing system 700 may be based on an ARM or RISC-V instruction set.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a feature extracting component 724A, a confusion matrix generating component 724B, a cluster identifying component 724C, a neural network training component 724D, and neural networks 724E. The depicted components, and others not depicted, may be configured to perform various aspects of the methods described herein.

Generally, the processing system 700 and/or components thereof may be configured to perform the methods described herein.

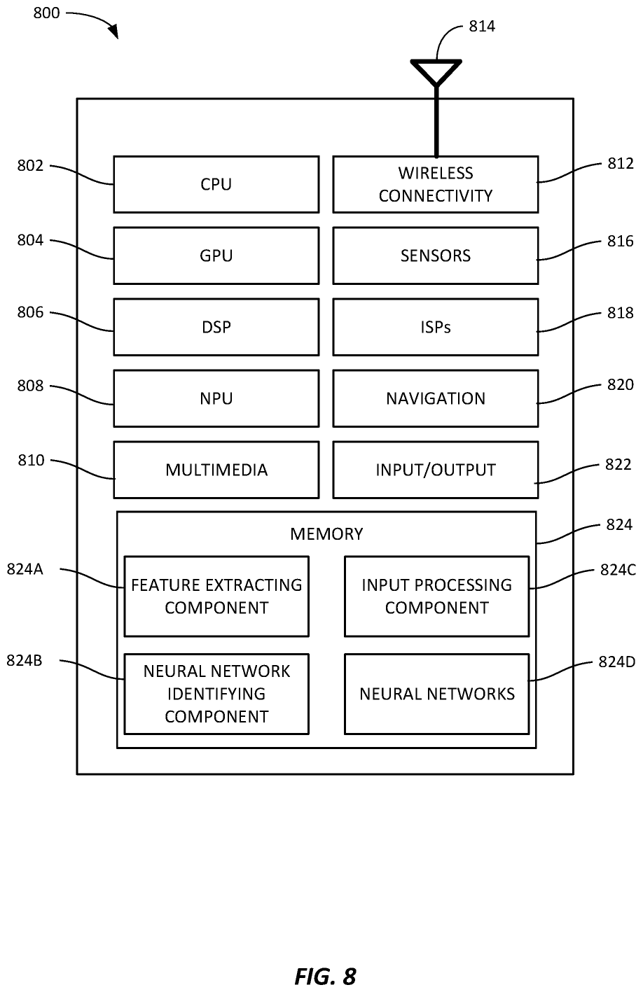

FIG. 8 depicts an example processing system 800 (or computing system) for inferencing using a multi-branch machine learning model for multi-input and multi-task processing, such as described herein for example with respect to FIG. 6.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., of memory 824).

The processing system 800 may also include additional processing components tailored to specific functions, such as a graphics processing unit (GPU) 804, a digital signal processor (DSP) 806, a neural processing unit (NPU) 808, and a connectivity component 812.

An NPU, such as the NPU 808, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 808 is a part of one or more of the CPU 802, the GPU 804, and/or the DSP 806. These may be located on a user equipment (UE) in a wireless communication system or another computing device.

In some examples, a connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 812 may be further coupled to one or more antennas (not shown).

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a feature extracting component 824A, a neural network identifying component 824B, an input processing component 824C, and neural networks 824D. The depicted components, and others not depicted, may be configured to perform various aspects of the methods described herein.

Generally, the processing system 800 and/or components thereof may be configured to perform the methods described herein.

### EXAMPLE CLAUSES

Implementation details of various aspects of the present disclosure are described in the following numbered clauses:

Clause 1: A processor-implemented method, comprising: extracting, using a first neural network block, a plurality of first features from a received input; identifying, using a gating neural network and the plurality of first features, a second neural network block from a plurality of second neural network blocks to use in processing the received input, each neural network in the plurality of second neural network blocks being trained to process data from a cluster of related domains in a universe of domains; and processing the received input using the identified second neural network block from the plurality of second neural network blocks.

Clause 2: The method of Clause 1, wherein processing the received input using the identified second neural network block comprises: extracting a plurality of second features from the received input using the identified second neural network block; identifying, using a gating neural network associated with the identified second neural network block, a third neural network from a plurality of third neural network blocks to use in processing the received input, each neural network in the plurality of third neural network blocks being trained to perform a specified task; and processing the received input using the identified third neural network from the plurality of third neural network blocks.

Clause 3: The method of Clauses 1 or 2, wherein extracting the plurality of first features from the received input comprises: extracting features usable by the gating neural network to identify the second neural network block from the plurality of second neural network blocks to process the received input, and extracting features usable by the second neural network block from the plurality of second neural network blocks to generate an inference from the received input.

Clause 4: The method of Clause 3, wherein the second neural network block comprises a feature extractor block and a task head configured to generate the inference based on features extracted by the feature extractor block.

Clause 5: The method of any of Clauses 1 through 4, wherein the gating neural network comprises a clustering neural network trained to classify an input into one of a plurality of data domains based on similarities to data in different data domains in a multi-domain data set.

Clause 6: The method of any of Clauses 1 through 5, wherein the first neural network block and the plurality of second neural network blocks comprise jointly trained neural network blocks.

Clause 7: The method of any of Clauses 1 through 6, wherein the plurality of second neural network blocks comprise neural networks trained to classify images from one of a plurality of image data domains.

Clause 8: The method of Clause 7, further comprising outputting an output of the image processing neural networks to an autonomous vehicle control system to trigger generation of one or more control signals to control an autonomous vehicle based on the output of the image processing neural networks.

Clause 9: The method of any of Clauses 1 through 8, wherein the plurality of second neural network blocks comprise generative artificial intelligence models trained to generate responses to prompts in one of a plurality of task-specific domains.

Clause 10: The method of any of Clauses 1 through 9, wherein the plurality of second neural network blocks comprise generative artificial intelligence models trained to generate responses to prompts in one of a plurality of data-specific domains.

Clause 11: A processor-implemented method, comprising: extracting, using a first neural network block, a plurality of features associated with inputs in a multi-domain input data set; generating a confusion matrix based on the extracted plurality of features; identifying a plurality of clusters from the confusion matrix, each cluster in the plurality of clusters corresponding to one or more data domains in the multi-domain input data set; training a first gating neural network based on the multi-domain input data set and the identified plurality of clusters; and training a plurality of second neural network blocks based on a division of the multi-domain input data set into data associated with each cluster of the plurality of clusters.

Clause 12: The method of Clause 11, wherein the first gating neural network comprises a neural network configured to output features associated with a received input to a neural network selected from the plurality of second neural network blocks for processing.

Clause 13: The method of Clauses 11 or 12, wherein identifying the plurality of clusters from the confusion matrix comprises identifying data domains in the multi-domain input data set having a clustering quality score above a threshold value.

Clause 14: The method of Clause 13, wherein the clustering quality score comprises a distance score associated with a sampling ratio of a first data domain and a second data domain from the multi-domain input data set, and wherein the distance score is based on: a joint distribution of data in the first data domain and the second data domain, and a product distribution of data in the first data domain and the second data domain.

Clause 15: The method of any of Clauses 11 through 14, wherein clusters in the plurality of clusters are divided based on types of data included in the multi-domain input data set.

Clause 16: The method of any of Clauses 11 through 15, wherein training the plurality of second neural network blocks comprises: training the first neural network block to extract a set of features from the multi-domain input data set including first features associated with the first gating neural network and second features associated with a downstream task performed by a second neural network block from the plurality of second neural network blocks; and training the second neural network block based on the second features.

Clause 17: The method of Clause 16, wherein training the first neural network block and the second neural network block comprises training the first neural network block and the second neural network block based on a joint loss function including a loss calculated for the first gating neural network and a loss calculated for the second neural network block.

Clause 18: The method of Clauses 16 or 17, wherein training the first neural network block to extract the first features and the second features comprises extracting a plurality of features through one or more temporary feature extractors.

Clause 19: The method of Clause 18, wherein the first neural network block comprises a frozen feature extractor configured to generate the first set of features and a plurality of trained feature extractors configured to generate the second set of features, the plurality of trained feature extractors being initialized based on parameters associated with a first feature extractor from the one or more temporary feature extractors.

Clause 20: The method of any of Clauses 11 through 19, further comprising: training a second gating neural network to route requests to one of a plurality of third neural network blocks, the second gating neural network being associated with a neural network from the plurality of second neural network blocks; and training the plurality of third neural network blocks to perform one or more specified tasks based on data in the multi-domain input data set associated with a cluster associated with the neural network from the plurality of second neural network blocks.

Clause 21: The method of claim 20, wherein the plurality of third neural network blocks comprises a plurality of classification neural networks trained to classify an input into one of a plurality of categories.

Clause 22: The method of any of Clauses 11 through 21, wherein the plurality of second neural network blocks comprise neural networks trained to classify images from one of a plurality of image data domains.

Clause 23: The method of any of Clauses 11 through 22, wherein the plurality of second neural network blocks comprise generative artificial intelligence models trained to generate responses to prompts in one of a plurality of task-specific domains or one of a plurality of data-specific domains.

Clause 24: The method of any of Clauses 11 through 23, wherein the plurality of second neural network blocks comprise image processing neural network blocks.

Clause 25: A processing system comprising: a memory having executable instructions stored thereon; and one or more processors configured to execute the executable instructions to cause the processing system to perform the operations of any of Clauses 1 through 24.

Clause 26: A processing system, comprising: means for performing the operations of any of Clauses 1 through 24.

Clause 27: A computer-readable medium having instructions stored thereon which, when executed by one or more processors, causes the one or more processors to perform the operations of any of Clauses 1 through 24.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions to cause the processing system to:
extract, using a first neural network block, a plurality of first features from a received input;
identify, using a gating neural network and the plurality of first features, a second neural network block from a plurality of second neural network blocks to use in processing the received input, each neural network in the plurality of second neural network blocks configured to process data from a cluster of domains in a universe of domains; and
process the received input using the identified second neural network block from the plurality of second neural network blocks.

2. The processing system of claim 1, wherein to process the received input using the identified second neural network block, the one or more processors are configured to cause the processing system to:
extract a plurality of second features from the first features using the identified second neural network block;
identify, using a gating neural network associated with the identified second neural network block, a third neural network from a plurality of third neural networks to use in processing the received input, each neural network in the plurality of third neural networks being trained to perform a specified task; and
process the received input using the identified third neural network from the plurality of third neural networks.

3. The processing system of claim 1, wherein to extract the plurality of first features from the received input, the one or more processors are configured to cause the processing system to:
extract features usable by the gating neural network to identify the second neural network block from the plurality of second neural network blocks to process the received input, and
extract features usable by the second neural network block from the plurality of second neural network blocks to generate an inference from the received input.

4. The processing system of claim 3, wherein the second neural network block comprises a feature extractor block and a task head configured to generate the inference based on features extracted by the feature extractor block.

5. The processing system of claim 1, wherein the gating neural network comprises a clustering neural network trained to classify an input into one of a plurality of data domains based on similarities to data in different data domains in a multi-domain data set.

6. The processing system of claim 1, wherein the first neural network block and the plurality of second neural network blocks comprise jointly trained neural network blocks.

7. The processing system of claim 1, wherein the plurality of second neural network blocks comprise image processing neural networks trained to classify images from one of a plurality of image data domains.

8. The processing system of claim 7, wherein the processor is further configured to cause the processing system to output an output of the image processing neural networks to an autonomous vehicle control system to trigger generation of one or more control signals to control an autonomous vehicle based on the output of the image processing neural networks.

9. The processing system of claim 1, wherein the plurality of second neural networks comprise generative artificial intelligence models trained to generate responses to prompts in one of a plurality of task-specific domains, and.

10. The processing system of claim 1, wherein the plurality of second neural network blocks comprise generative artificial intelligence models trained to generate responses to prompts in one of a plurality of data-specific domains.

11. A processor-implemented method, comprising:
extracting, using a first neural network block, a plurality of first features from a received input;
identifying, using a gating neural network and the plurality of first features, a second neural network block from a plurality of second neural network blocks to use in processing the received input, each neural network in the plurality of second neural network blocks being trained to process data from a cluster of related domains in a universe of domains; and
processing the received input using the identified second neural network block from the plurality of second neural network blocks.

12. The method of claim 11, wherein processing the received input using the identified second neural network block comprises:
extracting a plurality of second features from the first features using the identified second neural network block;
identifying, using a gating neural network associated with the identified second neural network block, a third neural network from a plurality of third neural networks to use in processing the received input, each neural network in the plurality of third neural networks being trained to perform a specified task; and
processing the received input using the identified third neural network from the plurality of third neural networks.

13. The method of claim 11, wherein extracting the plurality of first features from the received input comprises:
extracting features usable by the gating neural network to identify the second neural network block from the plurality of second neural network blocks to process the received input, and
extracting features usable by the second neural network block from the plurality of second neural network blocks to generate an inference from the received input.

14. The method of claim 13, wherein the second neural network block comprises a feature extractor block and a task head configured to generate the inference based on features extracted by the feature extractor block.

15. The method of claim 11, wherein the gating neural network comprises a clustering neural network trained to classify an input into one of a plurality of data domains based on similarities to data in different data domains in a multi-domain data set.

16. The method of claim 11, wherein the first neural network block and the plurality of second neural network blocks comprise jointly trained neural network blocks.

17. The method of claim 11, wherein the plurality of second neural network blocks comprise image processing neural networks trained to classify images from one of a plurality of image data domains.

18. The method of claim 17, further comprising outputting an output of the image processing neural networks to an autonomous vehicle control system to trigger generation of one or more control signals to control an autonomous vehicle based on the output of the image processing neural networks.

19. The method of claim 11, wherein the plurality of second neural networks comprise generative artificial intelligence models trained to generate responses to prompts in one of a plurality of task-specific domains, and.

20. The method of claim 11, wherein the plurality of second neural network blocks comprise generative artificial intelligence models trained to generate responses to prompts in one of a plurality of data-specific domains.

21. A processing system, comprising:
at least one memory having executable instructions stored thereon; and
one or more processors configured to execute the executable instructions to cause the processing system to:
extract, using a first neural network block, a plurality of features associated with inputs in a multi-domain input data set;
generate a confusion matrix based on the extracted plurality of features;
identify a plurality of clusters from the confusion matrix, each cluster in the plurality of clusters corresponding to one or more data domains in the multi-domain input data set;
train a first gating neural network based on the multi-domain input data set and the identified plurality of clusters; and
train a plurality of second neural network blocks based on a division of the multi-domain input data set into data associated with each cluster of the plurality of clusters.

22. The processing system of claim 21, wherein the first gating neural network comprises a neural network configured to output features associated with a received input to a neural network block selected from the plurality of second neural network blocks for processing.

23. The processing system of claim 21, wherein to identify the plurality of clusters from the confusion matrix, the one or more processors are configured to cause the processing system to identify data domains in the multi-domain input data set having a clustering quality score above a threshold value.

24. The processing system of claim 23, wherein the clustering quality score comprises a distance score associated with a sampling ratio of a first data domain and a second data domain from the multi-domain input data set, and wherein the distance score is based on:
a joint distribution of data in the first data domain and the second data domain, and
a product distribution of data in the first data domain and the second data domain.

25. The processing system of claim 21, wherein to train the plurality of second neural network blocks, the one or more processors are configured to cause the processing system to:
train the first neural network block to extract a set of features from the multi-domain input data set including a first set of features associated with the first gating neural network and a second set of features associated with a downstream task performed by a second neural network block from the plurality of second neural network blocks; and
train the second neural network block based on the second features.

26. The processing system of claim 25, wherein to train the first neural network block and the second neural network block, the one or more processors are configured to cause the processing system to train the first neural network block and the second neural network block based on a joint loss function including a loss calculated for the first gating neural network and a loss calculated for the second neural network block.

27. The processing system of claim 25, wherein to train the first neural network block to extract the first features and the second features, the one or more processors are configured to cause the processing system to extract a plurality of features through one or more temporary feature extractors.

28. The processing system of claim 27, wherein the first neural network block comprises a frozen feature extractor configured to generate the first set of features and a plurality of trained feature extractors configured to generate the second set of features, the plurality of trained feature extractors being initialized based on parameters associated with a first feature extractor from the one or more temporary feature extractors.

29. The processing system of claim 21, wherein the one or more processors are further configured to cause the processing system to:
train a second gating neural network to route requests to one of a plurality of third neural network blocks, the second gating neural network being associated with a neural network from the plurality of second neural network blocks; and
train the plurality of third neural network blocks to perform one or more specified tasks based on data in the multi-domain input data set associated with a cluster associated with the neural network from the plurality of second neural network blocks.

30. A processor-implemented method, comprising:
extracting, using a first neural network block, a plurality of features associated with inputs in a multi-domain input data set;
generating a confusion matrix based on the extracted plurality of features;
identifying a plurality of clusters from the confusion matrix, each cluster in the plurality of clusters corresponding to one or more data domains in the multi-domain input data set;
training a first gating neural network based on the multi-domain input data set and the identified plurality of clusters; and
training a plurality of second neural network blocks based on a division of the multi-domain input data set into data associated with each cluster of the plurality of clusters.
